(19) United States
(12) Patent Application Publication
(10) Pub. No.: US 2013/0249793 A1
(43) Pub. Date: Sep. 26, 2013

(54) TOUCH FREE USER INPUT RECOGNITION

(71) Applicants: Yanning Zhu, Snoqualmie, WA (US); Aleksey Fadeev, Seattle, WA (US)

(72) Inventors: Yanning Zhu, Snoqualmie, WA (US); Aleksey Fadeev, Seattle, WA (US)

(73) Assignee: INGEONIX CORPORATION, Snoqualmie, WA (US)

(21) Appl. No.: 13/427,320

(22) Filed: Mar. 22, 2012

(51) Int. Cl. G06F 3/033; G06F 3/01

(52) U.S. Cl. 345/157; 345/156

(57) ABSTRACT

Embodiments of electronic systems, devices, and associated methods of touch free user input recognition are described. In one embodiment, a method includes detecting a plurality of spatial positions of a user's finger or an object associated with the user's finger with respect to time. The method also includes calculating a section length and a direction change for a plurality of pairs of consecutive detected spatial positions of the user's finger or the object associated with the user's finger. The method further includes determining if a temporal trajectory formed by the plurality of spatial positions of the user's finger or the object associated with the user's finger correspond to natural shakiness of the user's finger based on the calculated section lengths and direction changes.

### BACKGROUND

Graphical user interface (“GUI”) allows users to interact with electronic devices based on images rather than text commands. For example, a GUI can represent information and/or actions available to users through graphical icons and visual indicators. Such representation is more intuitive and easier to operate than text-based interfaces, typed command labels, or text navigation.

To interact with GUIs, users typically utilize mice, touchscreens, touchpads, joysticks, and/or other human-machine interfaces (“HMIs”). However, such HMIs may not be suitable for certain applications. For example, mice may lack sufficient mobility for use with smart phones or tablet computers. Instead, touchscreens are typically used for such handheld devices. However, touchscreens may not allow precise cursor control because of limited operating surface area and/or touchscreen resolution. Various hands-free techniques have also been developed to interact with GUIs without HMIs. Example hands-free techniques include voice recognition and camera-based head tracking. These conventional hands-free techniques, however, can be difficult to use and limited in functionalities when compared to HMIs.

### BRIEF DESCRIPTION OF THE DRAWINGS

FIG. 1A is a schematic diagram of an electronic system configured for user input recognition in accordance with embodiments of the present technology.

FIG. 1B is a schematic diagram of another electronic system configured for user input recognition utilizing an input device in accordance with embodiments of the present technology.

FIG. 2 is a block diagram showing computing system software modules suitable for the system of FIG. 1A or 1B in accordance with embodiments of the present technology.

FIG. 3 is a block diagram showing software routines suitable for the process module of FIG. 2 in accordance with embodiments of the present technology.

FIG. 4A is a flowchart showing a process of user input recognition in accordance with embodiments of the present technology.

FIG. 4B is a flowchart showing a process of initializing a virtual frame in accordance with embodiments of the present technology.

FIG. 4C is a flowchart showing a process of detecting jittering in accordance with embodiments of the present technology.

FIG. 5 is a schematic spatial diagram showing a virtual frame in accordance with embodiments of the present technology.

FIGS. 6A and 6B are two dimensional x-y plots showing an example finger temporal trajectory and a corresponding cursor temporal trajectory, respectively, in accordance with embodiments of the present technology.

FIG. 7 is a two dimensional x-y plot showing a plurality of segments in an example finger temporal trajectory in accordance with embodiments of the present technology.

FIGS. 8A and 8B are plots showing an example finger temporal trajectory and a corresponding virtual frame trajectory, respectively, in accordance with embodiments of the present technology.

FIG. 9 is a plot showing an example finger temporal trajectory with slight motions in accordance with embodiments of the present technology.

### DETAILED DESCRIPTION

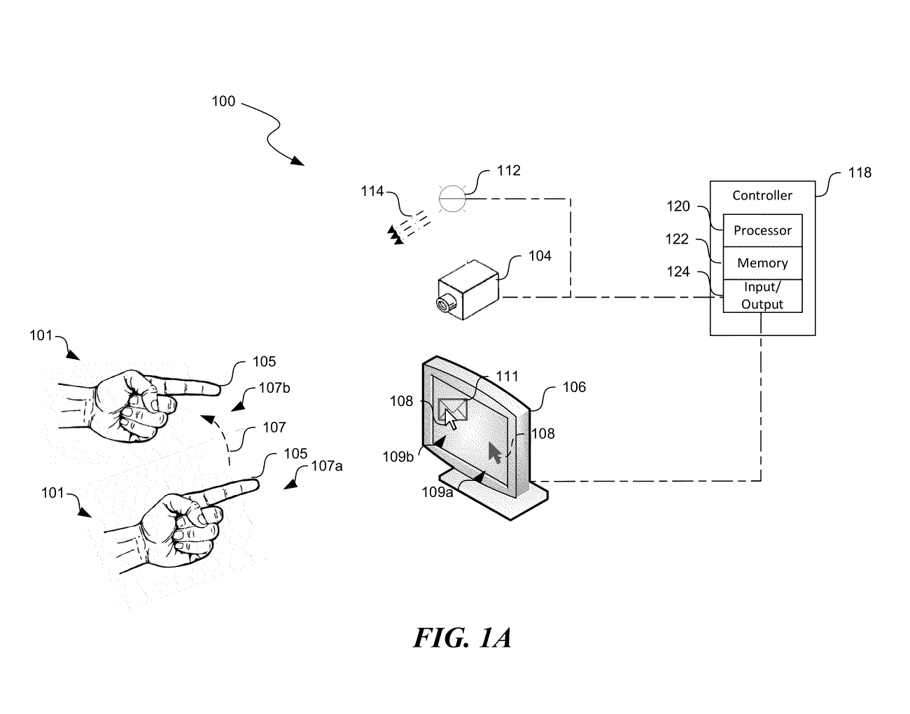

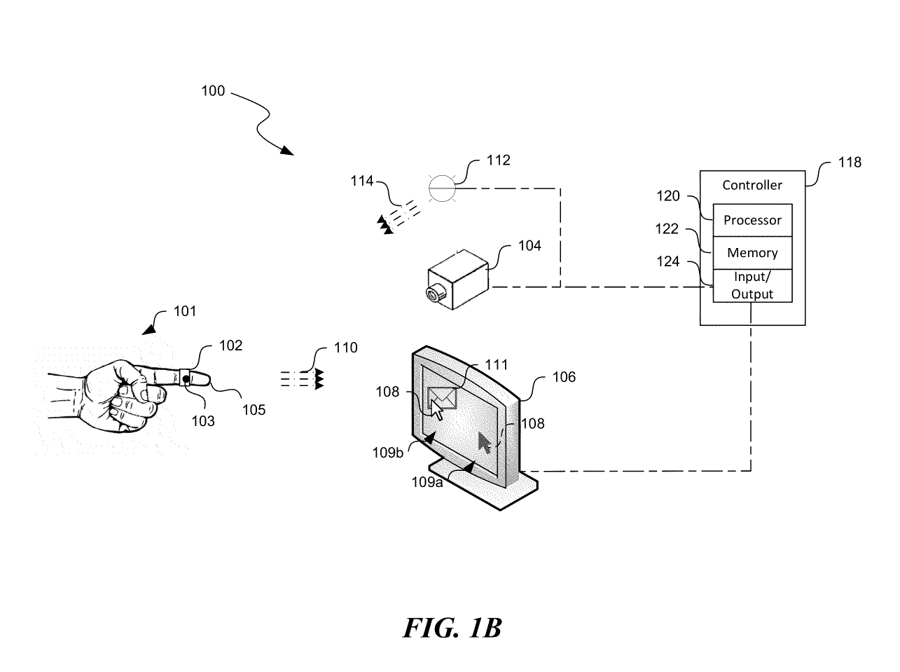

Various embodiments of electronic systems, devices, and associated methods of user input recognition are described below. The term “gesture” as used herein generally refers to a representation or expression based on a position, an orientation, and/or a movement trajectory of a finger, a hand, other parts of a user, and/or an object associated therewith. For example, a gesture can include a user's finger holding a generally static position (e.g., a canted position) relative to a reference point or plane. In another example, a gesture can include a user's finger moving toward or away from a reference point or plane over a period of time. In further examples, a gesture can include a combination of static and dynamic representations and/or expressions. A person skilled in the relevant art will also understand that the technology may have additional embodiments, and that the technology may be practiced without several of the details of the embodiments described below with reference to FIGS. 1A-9.

FIG. 1A is a schematic diagram of an electronic system 100 configured for user input recognition in accordance with embodiments of the present technology. As shown in FIG. 1A, the electronic system 100 can include a detector 104, an output device 106, and a controller 118 operatively coupled to one another. Optionally, the electronic system 100 can also include an illumination source 112 configured to provide illumination 114 to a finger 105 of a user 101. The illumination source 112 can include a fluorescent light bulb, a light emitting diode (“LED”), a laser, an infrared (“IR”) source, and/or other suitable sources configured to produce suitable types of illumination 114.

In the illustrated embodiment, the finger 105 is shown as an index finger on a left hand of the user 101. In other embodiments, the finger 105 can also be other suitable finger on either left or right hand of the user 101. Even though the electronic system 100 is describe below as being configured to monitor only the finger 105 for user input, in further embodiments, the electronic system 100 can also be configured to monitor two, three, or any suitable number of fingers on left hand and/or right hand of the user 101 for user input. In yet further embodiments, the electronic system 100 can also be configured to monitor at least one object (e.g., an input device 102 in FIG. 1B) associated with the finger 105. In further embodiments, the electronic system 100 can also be configured to monitor a hand, head, mouth, whole body, part of the user 101, and/or objects associated therewith.

The detector 104 can be configured to acquire images of and/or otherwise detect a current position of the finger 105 of the user 101. In the following description, a camera (e.g., Webcam C500 provided by Logitech of Fremont, Calif.) is used as an example of the detector 104. In other embodiments, the detector 104 can also include an IR camera, laser detector, radio frequency (“RF”) receiver, ultrasonic transducer, radar detector, and/or other suitable types of radio, image, and/or sound capturing component. Even though only one detector 104 is shown in FIG. 1A, in other embodiments, the electronic system 100 can include two, three, four, or any other suitable number of detectors (not shown) in a circular, semicircular, and/or other suitable arrangements relative to the finger 105.

The output device 106 can be configured to provide textual, graphical, sound, and/or other suitable types of feedback or display to the user 101. For example, as shown in FIG. 1A, the output device 106 includes a liquid crystal display (“LCD”) configured to display a computer cursor 108 and a mail 111 to the user 101. In other embodiments, the output device 106 can also include a touch screen, an LED display, an organic LED (“OLED”) display, an active-matrix organic LED (“AMOLED”) display, a projected display, a speaker, and/or other suitable output components.

The controller 118 can include a processor 120 coupled to a memory 122 and an input/output interface 124. The processor 120 can include a microprocessor (e.g., an A5 processor provided by Apple, Inc. of Cupertino, Calif.), a field-programmable gate array, and/or other suitable logic processing component. The memory 122 can include a volatile and/or nonvolatile computer readable medium (e.g., ROM; RAM, magnetic disk storage media; optical storage media; flash memory devices, EEPROM, and/or other suitable non-transitory storage media) configured to store data received from, as well as instructions for, the processor 120. The input/output interface 124 can include a driver for interfacing with a camera, display, touch screen, keyboard, track ball, gauge or dial, and/or other suitable types of input/output devices.

In certain embodiments, the controller 118 can be operatively coupled to the other components of the electronic system 100 via a hardwire communication link (e.g., a USB link, an Ethernet link, an RS232 link, etc.). In other embodiments, the controller 118 can be operatively coupled to the other components of the electronic system 100 via a wireless connection (e.g., a WIFI link, a Bluetooth link, etc.). In further embodiments, the controller 118 can be configured as an application specific integrated circuit, system-on-chip circuit, programmable logic controller, and/or other suitable computing framework.

In certain embodiments, the detector 104, the output device 106, and the controller 118 can be configured as a desktop computer, a laptop computer, a tablet computer, a smart phone, an electronic whiteboard, and/or other suitable types of electronic devices. In other embodiments, the output device 106 may be at least a part of a television set. The detector 104 and/or the controller 118 may be integrated into or separate from the television set. In further embodiments, the controller 118 and the detector 104 may be configured as a unitary component (e.g., a game console, a camera unit, or a projector unit), and the output device 106 may include a television screen, a projected screen, and/or other suitable displays. In further embodiments, the detector 104, the output device 106, and/or the controller 118 may be independent from one another or may have other suitable configurations.

Embodiments of the electronic system 100 can allow the user 101 to operate in a touch free fashion by, for example, positioning, orientating, moving, and/or otherwise gesturing with the finger 105. For example, the electronic system 100 can monitor a position, orientation, movement, and/or other gesture of the finger 105 and correlate the monitored gesture with a computing command, move instruction, and/or other suitable types of instruction. Techniques for determine a position, orientation, movement, and/or other gestures of the finger 105 can include monitoring and identifying a shape, color, and/or other suitable characteristics of the finger 105, as described in U.S. patent application Ser. Nos. 08/203,603 and 08/468,358, the disclosures of which are incorporated herein in their entirety.

In one operating mode, the user 101 can issue a move instruction by producing a movement of the finger 105 between a start position 107a and an end position 107b as indicated by an arrow 107. In response, the electronic system 100 detects the produced movement of the finger 105 via the detector 104, and then generates a move instruction by mapping the start and end positions 107a and 107b to the output device 106. The electronic system 100 then executes the move instruction by, for example, moving the computer cursor 108 from a first position 109a to a second position 109b corresponding to the start and end positions 107a and 107b of the finger 105.

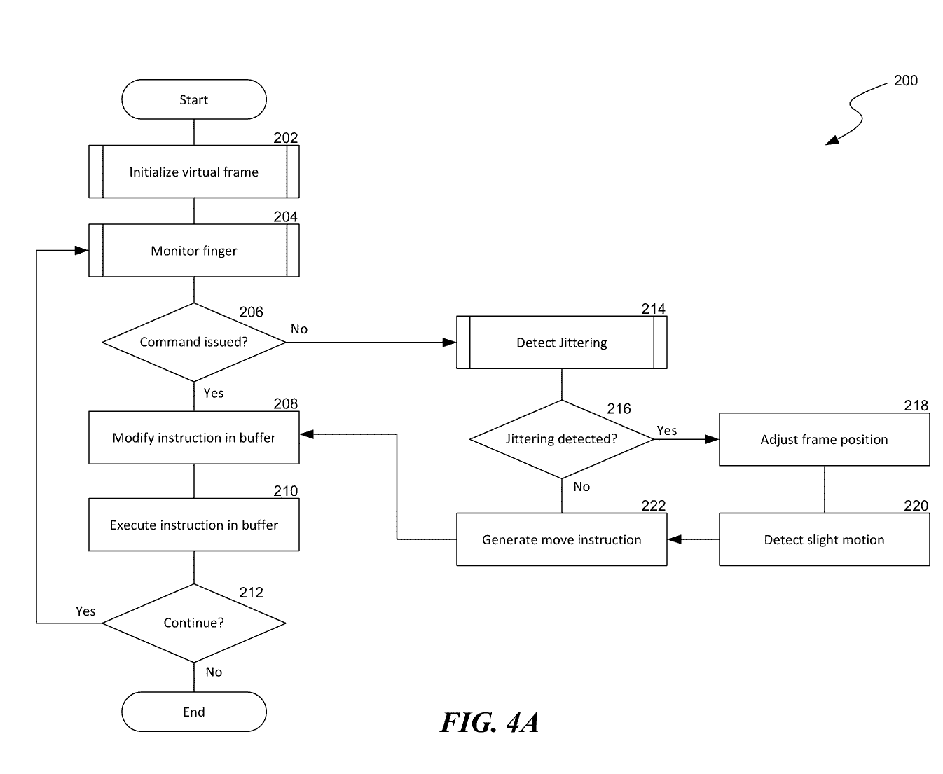

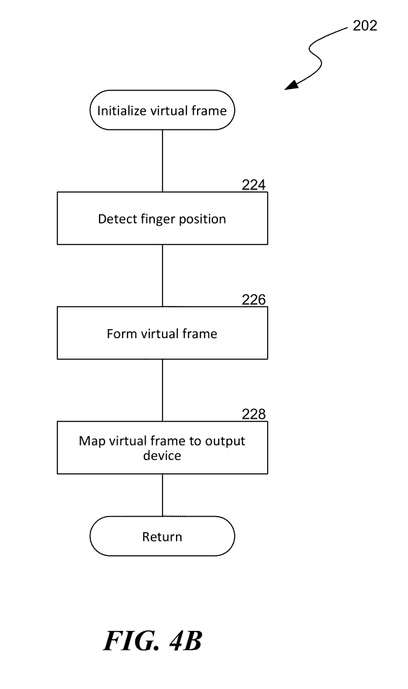

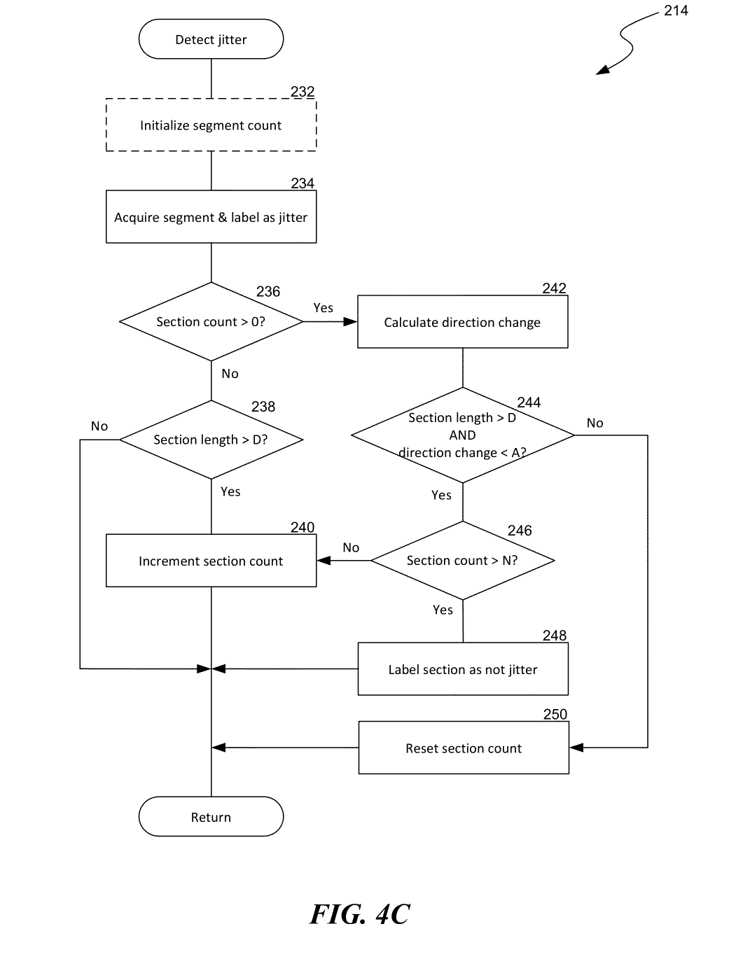

In another operating mode, the user 101 can also issue a computing command to the electronic system 100. In the example above, after the user 101 moved the computer cursor 108 to at least partially overlap the mail 111, the user 101 can then produce a gesture to signal an open command. An example gesture for an open command can include moving the finger 105 toward the detector 104 in a continuous motion and return immediately to approximately the original position. Other example gestures are described in U.S. patent application Ser. No. 13/363,569, the disclosures of which are incorporated herein in its entirety. The electronic system 100 then detects and interprets the movement of the finger 105 as corresponding to an open command before executing the open command to open the mail 111. Details of a process suitable for operations of the electronic system 100 are described below with reference to FIGS. 4A-4C.

Even though the electronic system 100 in FIG. 1A is described to monitor the finger 105 directly for gestures, in other embodiments, the electronic system 100 may also include at least one input component for facilitating monitoring gestures of the finger 105. For example, as shown in FIG. 1B, the electronic system 100 can also include an input device 102 associated with the finger 105. In the illustrated embodiment, the input device 102 is configured as a ring wearable on the finger 105. In other embodiments, the input device 102 may be configured as a ring wearable on other fingers of the user 101. In further embodiments, the input device 102 may be configured as an open ring, a finger probe, a finger glove, a hand glove, and/or other suitable item for a finger, a hand, and/or other parts of the user 101. Though only one input device 102 is shown in FIG. 1B, in other embodiments, the electronic system 100 may include more than one and/or other suitable input devices (not shown) associated with the user 101.

In certain embodiments, the input device 102 can include at least one marker 103 (only one is shown in FIG. 1B for clarity) configured to emit a signal 110 to be captured by the detector 104. In certain embodiments, the marker 103 can be an actively powered component. For example, the marker 103 can include an LED, an OLED, a laser diode (“LDs”), a polymer light emitting diode (“PLED”), a fluorescent lamp, an IR emitter, and/or other suitable light emitter configured to emit a light in the visible, IR, ultraviolet, and/or other suitable spectra. In other examples, the marker 103 can include a RF transmitter configured to emit a radio frequency, microwave, and/or other types of suitable electromagnetic signal. In further examples, the marker 103 can include an ultrasound transducer configured to emit an acoustic signal. In yet further examples, the input device 102 can include at least one emission source configured to produce an emission (e.g., light, RF, IR, and/or other suitable types of emission). The marker 103 can include a “window” or other suitable passage that allows at least a portion of the emission to pass through. In any of the foregoing embodiments, the input device 102 can also include a power source (not shown) coupled to the marker 103 or the at least one emission source.

In other embodiments, the marker 103 can include a non-powered (i.e., passive) component. For example, the marker 103 can include a reflective material that produces the signal 110 by reflecting at least a portion of the illumination 114 from the optional illumination source 112. The reflective material can include aluminum foils, mirrors, and/or other suitable materials with sufficient reflectivity. In further embodiments, the input device 102 may include a combination of powered and passive components. In any of the foregoing embodiments, one or more markers 103 may be configured to emit the signal 110 with a generally circular, triangular, rectangular, and/or other suitable pattern. In yet further embodiments, the marker 103 may be omitted.

The electronic system 100 with the input device 102 can operate in generally similar fashion as that described above with reference to FIG. 1A, facilitated by the input device 102. For example, in one embodiment, the detector 104 can be configured to capture images of the emitted signal 110 from the input device 102 for monitoring a position, orientation, movement, and/or other gestures of the finger 105, as described in U.S. patent application Ser. No. 13/342,554, the disclosure of which is incorporated herein in its entirety.

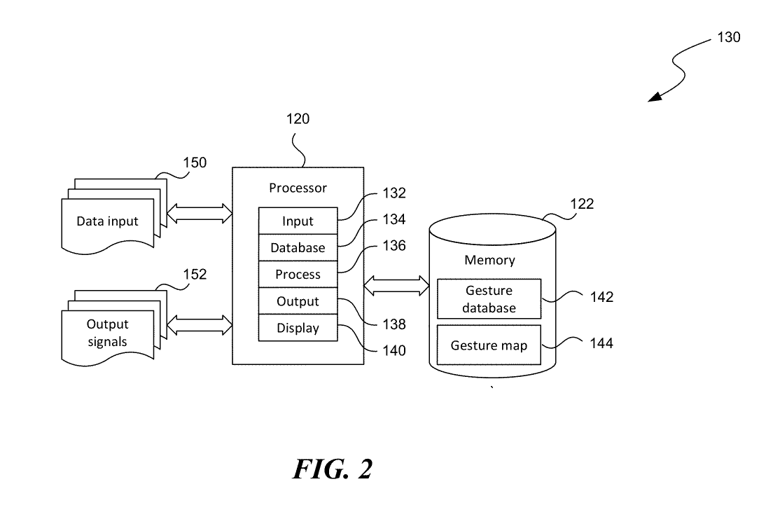

When implementing several embodiments of user input recognition discussed above, the inventors discovered that one difficulty of monitoring and recognizing gestures of the finger 105 is to distinguish between natural shaking and intended movements or gestures of the finger 105. Without being bound by theory, it is believed that human hands (and fingers) exhibit certain amounts of natural tremor, shakiness, or unsteadiness (collectively referred to herein as “jitter”) when held in air. The inventors have recognized that the natural shakiness may mislead, confuse, and/or otherwise affect gesture recognition of the finger 105. In response, several embodiments of the electronic system 100 are configured to identify and/or remove natural shakiness of the finger 105 (or the hand of the user 101) from intended movements or gestures, as discussed in more detail below with reference to FIGS. 2-9.

The inventors have also discovered that distinguishing gestures corresponding to move instructions from those corresponding to computing commands is useful for providing good user experience. For instance, in the example shown in FIG. 1A, after the user 101 moves the computer cursor 108 to at least partially overlap with the mail 111, the computer cursor 108 should not move any more as the finger 105 produces the gesture corresponding to an open command. Otherwise, the previously defined position of the computer cursor 108 may be offset from the mail 111 and thus causing user frustration. Several embodiments of the electronic system 100 are configured to at least ameliorate the foregoing difficulty, as discussed in more detail below with reference to FIGS. 2-9.

FIG. 2 is a block diagram showing computing system software modules 130 suitable for the controller 118 in FIG. 1A or 1B in accordance with embodiments of the present technology. Each component may be a computer program, procedure, or process written as source code in a conventional programming language, such as the C++ programming language, or other computer code, and may be presented for execution by the processor 120 of the controller 118. The various implementations of the source code and object byte codes may be stored in the memory 122. The software modules 130 of the controller 118 may include an input module 132, a database module 134, a process module 136, an output module 138 and a display module 140 interconnected with one another.

In operation, the input module 132 can accept data input 150 (e.g., images from the detector 104 in FIG. 1A or 1B), and communicates the accepted data to other components for further processing. The database module 134 organizes records, including a gesture database 142 and a gesture map 144, and facilitates storing and retrieving of these records to and from the memory 122. Any type of database organization may be utilized, including a flat file system, hierarchical database, relational database, or distributed database, such as provided by a database vendor such as the Oracle Corporation of Redwood Shores, Calif.

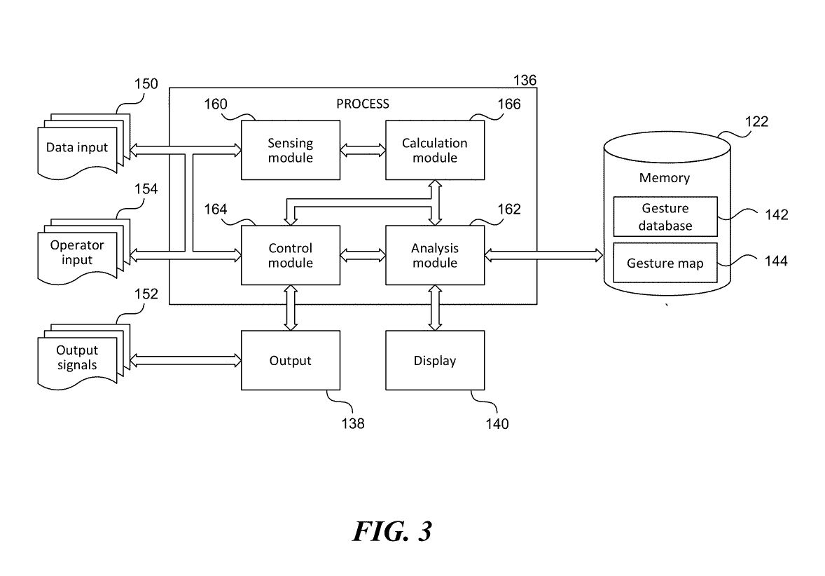

The process module 136 analyzes the data input 150 from the input module 132 and/or other data sources, and the output module 138 generates output signals 152 based on the analyzed data input 150. The processor 120 may include the display module 140 for displaying, printing, or downloading the data input 150, the output signals 152, and/or other information via the output device 106 (FIG. 1A or 1B), a monitor, printer, and/or other suitable devices. Embodiments of the process module 136 are described in more detail below with reference to FIG. 3.

FIG. 3 is a block diagram showing embodiments of the process module 136 in FIG. 2. As shown in FIG. 3, the process module 136 may further include a sensing module 160, an analysis module 162, a control module 164, and a calculation module 166 interconnected with one other. Each module may be a computer program, procedure, or routine written as source code in a conventional programming language, or one or more modules may be hardware modules.

The sensing module 160 is configured to receive the data input 150 and identify the finger 105 (FIG. 1A) and/or the input device 102 (FIG. 1B) based thereon. For example, in certain embodiments, the data input 150 includes a still image (or a video frame) of the finger 105 and/or the input device 102, the user 101 (FIG. 1A), and background objects (not shown). The sensing module 160 can then be configured to identify pixels and/or image portions in the still image that correspond to the finger 105 and/or the markers 103 (FIG. 1B) of the input device 102. Based on the identified pixels and/or image portions, the sensing module 160 forms a processed image of the finger 105 and/or the markers 103 of the input device 102.

The calculation module 166 may include routines configured to perform various types of calculations to facilitate operation of other modules. For example, the calculation module 166 can include a sampling routine configured to sample the data input 150 at regular time intervals along preset directions. In certain embodiments, the sampling routine can include linear or non-linear interpolation, extrapolation, and/or other suitable subroutines configured to generate a set of data, images, frames from the detector 104 (FIG. 1A) at regular time intervals (e.g., 30 frames per second) along x-, y-, and/or z-direction. In other embodiments, the sampling routine may be omitted.

The calculation module 166 can also include a modeling routine configured to determine a position and/or orientation of the finger 105 and/or the input device 102 relative to the detector 104. In certain embodiments, the modeling routine can include subroutines configured to determine and/or calculate parameters of the processed image. For example, the modeling routine may include subroutines to determine an angle of the finger 105 relative to a reference plane. In another example, the modeling routine may also include subroutines that calculate a quantity of markers 103 in the processed image and/or a distance between individual pairs of the markers 103.

In another example, the calculation module 166 can also include a trajectory routine configured to form a temporal trajectory of the finger 105 and/or the input device 102. As used herein, the term “temporal trajectory” generally refers to a spatial trajectory of a subject of interest (e.g., the finger 105 or the input device 102) over time. In one embodiment, the calculation module 166 is configured to calculate a vector representing a movement of the finger 105 and/or the input device 102 from a first position/orientation at a first time point to a second position/orientation at a second time point. In another embodiment, the calculation module 166 is configured to calculate a vector array or plot a trajectory of the finger 105 and/or the input device 102 based on multiple position/orientation at various time points.

In other embodiments, the calculation module 166 can include linear regression, polynomial regression, interpolation, extrapolation, and/or other suitable subroutines to derive a formula, a linear fit, and/or other suitable representation of movements of the finger 105 and/or the input device 102. In yet other embodiments, the calculation module 166 can include routines to compute a travel distance, travel direction, velocity profile, and/or other suitable characteristics of the temporal trajectory. In further embodiments, the calculation module 166 can also include counters, timers, and/or other suitable routines to facilitate operation of other modules, as discussed in more detail below with reference to FIGS. 4A-9.

The analysis module 162 can be configured to analyze the calculated temporal trajectory of the finger 105 and/or the input device 102 to determine a corresponding user gesture. In certain embodiments, the analysis module 162 analyzes characteristics of the calculated temporal trajectory and compares the characteristics to the gesture database 142. For example, in one embodiment, the analysis module 162 can compare a travel distance, travel direction, velocity profile, and/or other suitable characteristics of the temporal trajectory to known actions or gesture in the gesture database 142. If a match is found, the analysis module 166 is configured to indicate the identified particular gesture.

The analysis module 162 can also be configured to correlate the identified gesture to a control instruction based on the gesture map 144. For example, if the identified user action is a lateral move from left to right, the analysis module 162 may correlate the gesture to a move instruction for a lateral cursor shift from left to right, as shown in FIG. 1A. In another example, the analysis module 162 may correlate another gesture to an open command for opening the mail 111 (FIG. 1A). In other embodiments, the analysis module 162 may correlate various user actions or gestures with other suitable commands and/or mode change.

The control module 164 may be configured to control the operation of the electronic system 100 (FIG. 1A or 1B) based on instructions identified by the analysis module 162. For example, in one embodiment, the control module 164 may include an application programming interface (“API”) controller for interfacing with an operating system and/or application program of the controller 118. In other embodiments, the control module 164 may include a routine that generates one of the output signals 152 (e.g., a control signal of cursor movement) to the output module 138 based on the identified control instruction. In further example, the control module 164 may perform other suitable control operations based on operator input 154 and/or other suitable input. The display module 140 may then receive the determined instructions and generate corresponding output to the user 101.

FIG. 4A is a flowchart showing a process 200 for user input recognition in accordance with embodiments of the present technology. Even though the process 200 is described below with reference to the electronic system 100 of FIG. 1A or 1B and the software modules of FIGS. 2 and 3, the process 200 may also be applied in other electronic systems with additional and/or different hardware/software components.

Referring to FIGS. 1A, 1B, and 4A, the process 200 can include initializing a virtual frame corresponding to a position of the finger 105 at stage 202. For example, the detector 104 can capture an image and/or otherwise detect a position of the finger 105, which is spaced apart from the output device 106. The controller 118 may then define a virtual frame based at least in part on the detected position of the first 105. The controller 118 can then map positions in the virtual frame to corresponding positions on the output device 106. Details of several embodiments of initializing a virtual frame are described in more detail below with reference to FIG. 4B.

Another stage 204 of the process 200 can include monitoring a position, orientation, movement, or gesture of the finger 105 relative to the virtual frame. For example, the detector 104 can detect, acquire, and/or record positions of the finger 105 relative to the virtual frame over time. The detected positions of the finger 105 may then be used to form a temporal trajectory. The controller 118 can then compare the formed temporal trajectory with known actions or gestures in the gesture database 142 (FIG. 2) to determine a user gesture. The controller 118 can then determine if the derived gesture corresponds to a computing command based on the gesture map 144 (FIG. 2).

The process 200 can include a decision stage 206 to determine if the gesture of the finger 105 corresponds to a computing command. If the gesture corresponds to a computing command, in one embodiment, the process 200 includes inserting the computing command into a buffer (e.g., a queue, stack, and/or other suitable types of data structure) awaiting execution by the processor 120 of the controller 118 at stage 208. In another embodiment, the process 200 can also include modifying a previously inserted computing command and/or move instruction in the buffer at stage 208. For example, a previously inserted move instruction may be deleted from the buffer before being executed. Subsequently, a computing command is inserted into the buffer. The process 200 then includes executing commands in the buffer after a certain amount of delay at stage 210. In one embodiment, the delay is about 0.1 seconds. In other embodiments, the delay can be about 10 milliseconds, about 20 milliseconds, about 50 milliseconds, about 0.5 seconds, and/or other suitable amount of delay.

Several embodiments of the process 200 can thus at least ameliorate the difficulty of distinguishing between gestures for move instruction and those for computing commands. For example, when a movement of the finger 105 is first detected, the movement may be insufficient (e.g., short travel distance, low speed, etc.) to be recognized as a computing command. Thus, move instructions may be inserted into the buffer based on the detected movement. After a certain period of time (e.g., 0.5 seconds), the movement of the finger 105 is sufficient to be recognized as a gesture corresponding to a computer command. In response, the process 200 includes deleting the previously inserted move instruction and inserting the computing command instead. As such, the computer cursor 108 may be maintained generally stationary when the user 101 issues a computing command after moving the computer cursor 108 to a desired location.

If the gesture does not correspond to a computing command, the process 200 includes detecting jittering at stage 214 to determine if at least a portion of the monitored temporal trajectory of the finger 105 corresponds to natural shakiness of a human hand. In certain embodiments, detecting jittering can include analyzing the monitored temporal trajectory of the finger 105 for an established direction. In other embodiments, detecting jitters can include analyzing a travel distance, a travel speed, other suitable characteristics of the temporal trajectory, and/or combinations thereof. Several embodiments of detecting jitters by analyzing the monitored temporal trajectory for an established direction are described in more detail below with reference to FIG. 4C.

The process 200 then includes another decision stage 216 to determine if jittering is detected. If jittering is detected, the process 200 includes adjusting the virtual frame to counteract (e.g., at least reduce or even cancel) the impact of the detected jittering at stage 218. For example, the virtual frame may be adjusted based on the amount, direction, and/or other suitable characteristics of the monitored temporal trajectory of the finger 105. In one embodiment, a center of the virtual frame is shifted by an amount that is generally equal to an amount of detected jittering along generally the same direction. In other embodiments, the virtual frame may be tilted, scaled, rotated, and/or may have other suitable adjustments.

The process 200 can also include detecting slight motions of the finger 105 at stage 220. The inventors have recognized that the user 101 may utilize slight motions of the finger 105 for finely adjusting and/or controlling a position of the computing cursor 108. Unfortunately, such slight motions may have characteristics generally similar to those of jittering. As a result, the electronic system 100 may misconstrue such slight motions as jittering.

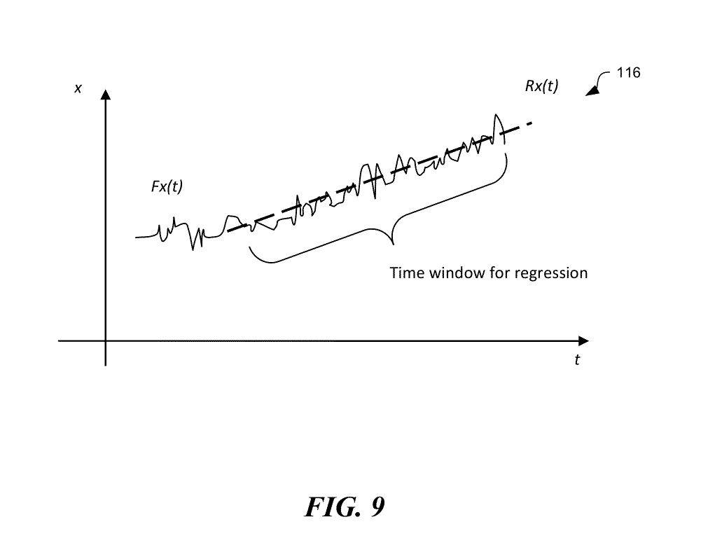

Several embodiments of the process 200 can recognize such slight motions to allow fine control of cursor position on the output device 106. As used herein, the term a “slight motion” generally refers to a motion having a travel distance, directional change, and/or other motion characteristics generally similar to jittering of a user's hand. In certain embodiments, recognizing slight motions may include performing linear regressions on the temporal trajectory of the finger 105 and determine a slope of the regressed fit, as discussed in more detail below with reference to FIG. 9. In other embodiments, slight motions may also be recognized by performing logistic regression, non-linear regression, stepwise regression, and/or other suitable analysis on the temporal trajectory of the finger 105.

The process 200 then includes generating a move instruction at stage 222 if no jittering is detected or a slight motion is determined. Generating the move instruction can include computing a computer cursor position based on the temporal trajectory of the finger 105 and mapping the computed cursor position to the output device 106. The process 200 than proceeds to inserting the generated move instruction to the buffer at stage 208.

The process 200 then includes a decision stage 212 to determine if the process 200 should continue. In one embodiment, the process is continued if further movement of the finger 105 and/or the input device 102 is detected. In other embodiments, the process 200 may be continued based on other suitable criteria. If the process is continued, the process reverts to monitoring finger gesture at stage 204; otherwise, the process ends.

Even though the process 200 is shown in FIG. 4A as having adjusting frame position at stage 218 followed by detecting slight motions at stage 220, in other embodiments, the process 200 can include detecting slight motions at 220 if jittering is detected. Subsequently, the process proceeds to adjusting frame position at stage 218 before generating a move instruction at stage 222. In further embodiments, the process 200 may also include a buffer when monitoring a position, orientation, movement, or gesture of the finger 105 at stage 204. Thus, the determination at stage 206 may be delayed by about 0.1 seconds, about 10 milliseconds, about 20 milliseconds, about 50 milliseconds, about 0.5 seconds, and/or other suitable amount of time. In these embodiments, the modifying command in the buffer at stage 208 may be omitted, and instructions may be executed without delay at stage 210.

FIG. 4B is a flowchart showing a process 202 of initializing a virtual frame in accordance with embodiments of the present technology. Referring to FIGS. 1A, 1B, and 4B, the process 202 can include detecting a position of the finger 105 at stage 224. In one embodiment, detecting a position of the finger 105 can include capturing an image of and identifying a shape (e.g., a fingertip), color, and/or other suitable characteristics of the finger 105 based on the captured image. In other embodiments, detecting a finger position can include identifying emitted and/or reflected signals 110 from the input device 102.

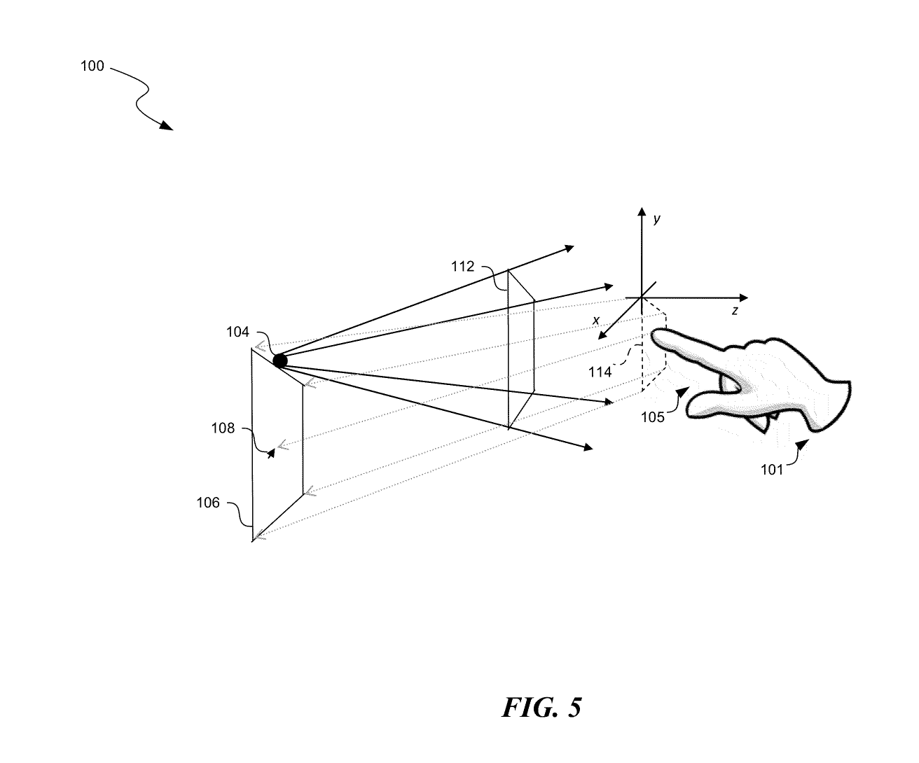

Based on the detected position of the finger 105, the process 202 can include defining a virtual frame at stage 226. In one embodiment, the virtual frame includes an x-y plane (or a plane generally parallel thereto) in an x-y-z coordinate system based on a fingertip position of the finger 105. For example, the virtual frame can be a rectangular plane generally parallel to the output device 106 and has a center that generally coincides with the detected position of the finger 105. The virtual frame can have a size generally corresponding to a movement range along x-, y-, and z-axis of the finger 105. In other embodiments, the virtual frame may have other suitable locations and/or orientations. An example virtual frame is discussed in more detail below with reference to FIG. 5.

The process 204 then includes mapping the virtual frame to the output device 106 at stage 228. In one embodiment, the virtual frame is mapped to the output device 106 based on a display size of the output device 106 (e.g., in number of pixels). As a result, each finger position in the virtual frame has a corresponding position on the output device 106. In other embodiments, the virtual frame may be mapped to the output device 106 in other suitable fashions. The process 202 then returns with the initiated virtual frame.

FIG. 4C is a flowchart showing a process 214 of detecting jittering in accordance with embodiments of the present technology. The inventors have recognized that jittering typically does not have significant directional movements. As a result, several embodiments of the process 214 include detecting jittering by analyzing section length and directional change of a temporal trajectory of the finger 105 (FIG. 1A or 1B) based on predetermined thresholds. As used herein a “section” generally refers to a vector between two consecutive spatial positions of the finger 105 with respect to time. Thus, at least two spatial positions (or position points) are needed to establish a section with a section length and a section direction. Also, in the following discussion, an angle change is used as an indicator of directional change. In other embodiments, the directional change may also be represented by other suitable parameters. Even though particular example operations and/or sequences are discussed below, in other embodiments, the process 214 may include additional and/or different operations for detecting jittering by analyzing section length and directional change of a temporal trajectory of the finger 105.

As shown in FIG. 4C, the process 214 includes an optional stage 232 in which a section count is initialized. As used herein, a “section count” corresponds to a number of sections with section lengths greater than a predetermined length threshold D (e.g., 0.1 mm, 0.2 mm, or any other suitable values). In one embodiment, the section count is initialized to zero when the process 214 is performed for the first time. In other embodiments, the section count may be initialized when initializing the virtual frame at stage 202 (FIG. 4A). In further embodiments, the section count may be initialized in other suitable fashion or may be omitted.

The process 214 then includes acquiring a section and labeling the acquired section as jitter at stage 234. In one embodiment, acquiring a section includes detecting a position of the finger 105 relative to the virtual frame and calculating a vector based on the detected position and a previous position with respect to time. In other embodiments, acquiring a section may include retrieving at least two positions of the finger 105 from the memory 122 (FIG. 2) and calculating a vector based thereon. In further embodiments, a section may be acquired via other suitable techniques.

The process 214 then includes a decision stage 236 to determine if the section count has a value that is greater than zero. If the section count currently has a value of zero, the process 214 includes another decision stage 238 to determine if the section length of the acquired section is greater than the length threshold D. If the section length is greater than the length threshold D, the process 214 includes incrementing the section count at stage 240 before the process returns. The section count may be incremented by one or any other suitable integer. If the section length is not greater than the length threshold D, the process returns without incrementing the section count.

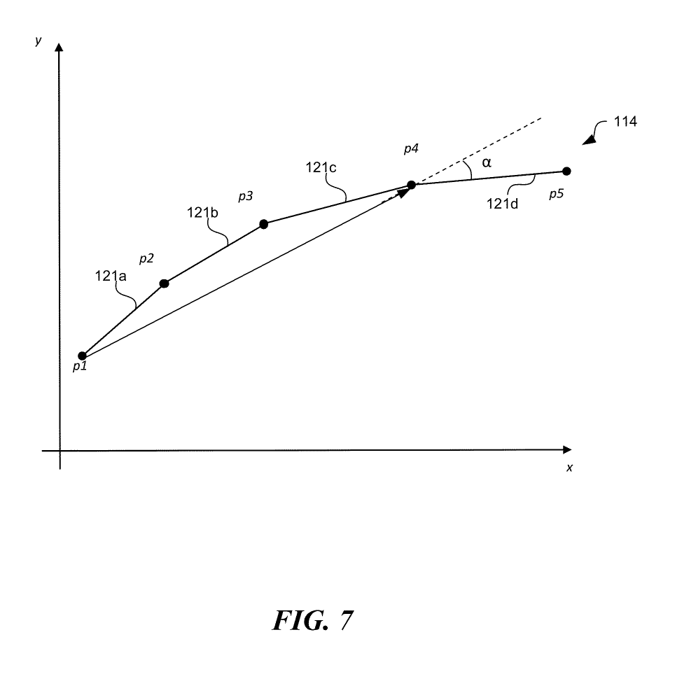

If the section count has a current value that is greater than zero, the process 214 then includes calculating a direction change of the current section at stage 242. In one embodiment, calculating a direction change includes calculating an angle change between a direction of the current section and that defined by prior positions of the finger 105. An example angle change is schematically shown in FIG. 7. In another embodiment, calculating a direction change includes calculating an angle change between the direction of the current section and that of an immediate preceding section. In other embodiments, calculating a section direction change can include calculating an angle change between a direction of the current section and the direction of any preceding sections or combinations thereof.

The process 214 then includes a decision block 244 to determine if the section length is greater than the length threshold D and the calculated direction change is lower than an angle change threshold A. If no, the process 214 includes resetting the section count, for example, to zero and optionally indicating the plurality of spatial positions of the user's finger or the object associated with the user's finger correspond to natural shakiness at stage 250. If yes, the process 214 includes another decision stage 246 to determine if the section count has a current value greater than a count threshold N. The count threshold N may be predetermined to correspond to a minimum number of sections that indicate an intentional movement of the finger 105. In one embodiment, the count threshold N is three. In other embodiments, the count threshold N can be 1, 2, 4, or any other suitable integer values.

If the section count has a current value greater than the count threshold N, in one embodiment, the process 214 includes labeling the current section as not jitter at stage 248. In other embodiments, the process 214 may also label at least some or all of the previous sections in the section count as not jitters at stage 248. The process then returns. If the section count has a current value not greater than the count threshold N, the process 214 includes proceeding to incrementing the section count at stage 240 before the process returns.

FIG. 5 is a schematic spatial diagram showing a virtual frame 114 in accordance with embodiments of the present technology. As shown in FIG. 5, the detector 104 has a field of view 112 facing the virtual frame 114 based on a position of the finger 105. As discussed above, by mapping the virtual frame 114 to the output device 106, the finger position (e.g., position of the fingertip) can be mapped to a position of the cursor 108 on the output device 106. Thus, when the user 101 moves the finger 105, the electronic system 100 can move the cursor 108 accordingly. In the illustrated embodiment and in the description below, the virtual frame 114 is generally parallel to the x-y plane, which generally corresponds to a plane of the detector 104. The z-axis corresponds to an axis generally perpendicular to the x-y plane and extending from the detector 104 toward the finger 105. In other embodiments, other suitable coordinate systems may also be used.

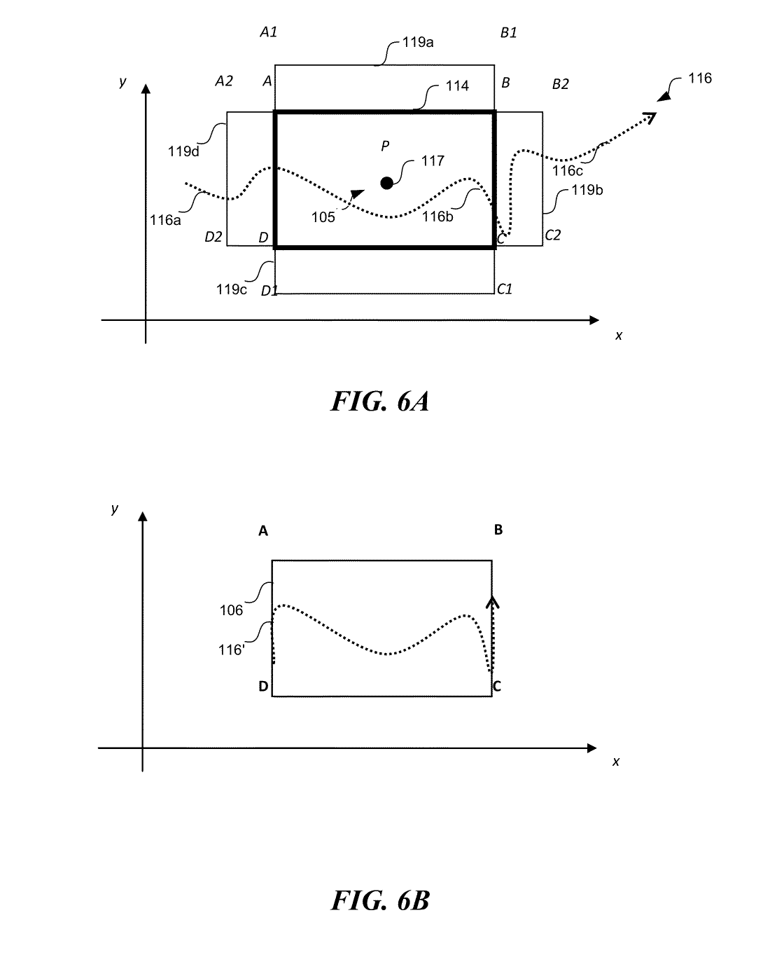

FIGS. 6A and 6B are two dimensional x-y plots showing an example finger temporal trajectory 116 relative to a virtual frame 114 and a corresponding cursor temporal trajectory 116′ relative to an output device 106, respectively. In the illustrated embodiment shown in FIG. 6A, the virtual frame 114 is defined as a rectangle ABCD with a center 117 that coincides with a position of the finger 105 (FIG. 5). As shown in FIG. 6B, the output device 106 includes an output area generally corresponding to the rectangle ABCD in the virtual frame 114. In other embodiments, the virtual frame 114 and/or the corresponding output area of the output device 106 may be defined as a circle, an oval, a trapezoid, and/or other suitable geometric shapes and/or configurations.

The virtual frame 114 also includes first, second, third, and fourth peripheral frames 119a, 119b, 119c, and 119d shown in FIG. 6A as rectangles AA1B1B, BB2C2C, CC1D1D, and AA2D2D, respectively. The peripheral frames 119 may be configured to facilitate mapping the finger temporal trajectory 116 to the cursor temporal trajectory 116′ when outside of the virtual frame 114. For example, as shown in FIGS. 6A and 6B, first and third sections 116a and 116c of the finger temporal trajectory 116 are inside the second and fourth peripheral frames 119b and 119d, respectively. As a result, in the first and third sections 116a and 116c, movement changes generally parallel to the x-axis may be omitted. However, movement changes generally parallel to the y-axis may be translated into the cursor trajectory 116′. As shown in FIGS. 6A and 6B, the second section 116b of the finger temporal trajectory 116 is inside the virtual frame 114. As a result, movement changes generally parallel to both the x-axis and the y-axis are translated into the cursor temporal trajectory 116′.

FIG. 7 is a two dimensional x-y plot showing a plurality of sections in an example finger temporal trajectory 114 in accordance with embodiments of the present technology. As shown in FIG. 7, the example finger temporal trajectory 114 includes five position points p1-p5, respectively, with respect to time. As a result, the five position points p1-p5 can define first, second, third, and fourth sections 121a, 121b, 121c, and 121d, respectively, between successive position points. In other embodiments, the finger temporal trajectory 114 can include any other suitable number of position points and sections.

In the example shown in FIG. 7, the first, second, and third sections 121a, 121b, and 121c are established sections with section lengths greater than a length threshold D and with direction changes lower than an angle change threshold A. Thus, after the fifth position point p5 is detected, the fourth section 121d is acquired by calculating a section length between the fourth and fifth position points p4 and p5. Also, a direction change (as represented by an angle change a) is also calculated based on a direction of the fourth section 121d and a vector defined by the first position point p1 and the fourth position point p4. In other embodiments, the angle change a may be calculated based on a direction of the fourth section 121d and a vector defined by any of the first, second, third, and fourth position points p1, p2, p3, and p4. In further embodiments, the angle change a may be calculated based on other suitable parameters. Thus, as discussed above with reference to FIG. 4C, if the section length of the fourth section 121d is greater than the length threshold D and the angle change is lower than the angle change threshold A, at least the fourth section 121d can be indicated as not jitter.

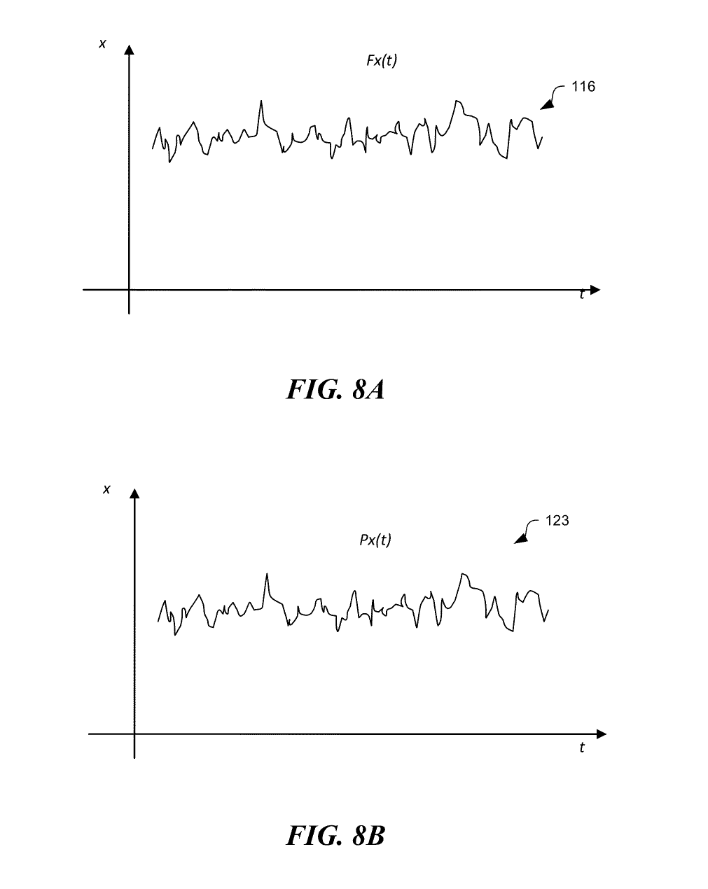

FIGS. 8A and 8B are plots showing an example finger temporal trajectory 116 and a corresponding virtual frame position 123, respectively, in accordance with embodiments of the present technology. As discussed above with reference to FIG. 4A, if a section or sections are indicated to be jittering, then a position of the virtual frame can be adjusted accordingly. FIG. 8A shows an example finger temporal trajectory Fₓ(t) 116 deemed to be jittering. FIG. 8B shows the virtual frame position Fₓ(t) 123 of the virtual frame 114 (FIG. 5) adjusted accordingly to at least reduce or even cancel the impact of the jittering.

FIG. 9 is a plot showing an example finger temporal trajectory 116 with slight motions in accordance with embodiments of the present technology. As shown in FIG. 9, linear regression may be performed on the finger temporal trajectory Fₓ(t) 116 over a moving time window (e.g., 0.2, 0.3, 0.4, or any other suitable time periods) to derive a linear fit Rₓ(t). If the linear fit Rₓ(t) has a slope greater than a threshold (e.g., 0, 0.1, or any other suitable slope values), the finger temporal trajectory 116 may be indicated as a slight motion.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method implemented in a computing device having a processor, a detector, and a display operatively coupled to one another, the method comprising:
monitoring a temporal trajectory of a user's finger or an object associated with the user's finger with the detector, the temporal trajectory having a plurality of spatial positions of the user's finger or the object with respect to time, wherein the user's finger or the object is spaced apart from the display;
determining if the monitored temporal trajectory corresponds to natural shakiness of the user's finger; and
if the monitored temporal trajectory does not correspond to natural shakiness of the user's finger, individually mapping the monitored spatial positions of the user's finger or the object to a corresponding cursor position on the display.

2. The method of claim 1, further comprising if the monitored temporal trajectory corresponds to natural shakiness of the user's finger, maintaining a cursor position on the display.

3. The method of claim 1, further comprising:
with the detector, detecting a spatial position of the user's finger or the object relative to the display; and
forming a virtual frame with the processor based on the detected position, wherein monitoring the temporal trajectory includes monitoring a temporal trajectory of the user's finger or the object relative to the virtual frame.

4. The method of claim 1, further comprising:
with the detector, detecting a spatial position of the user's finger or the object relative to the display;
forming a virtual frame with the processor based on the detected position, wherein
monitoring the temporal trajectory includes monitoring a temporal trajectory of the user's finger or the object relative to the virtual frame; and
if the monitored temporal trajectory corresponds to natural shakiness of the user's finger, adjusting a spatial position of the virtual frame based on the monitored temporal trajectory.

5. The method of claim 1, further comprising:
with the detector, detecting a spatial position of the user's finger or the object relative to the display;
forming a virtual frame with the processor based on the detected position, wherein
monitoring the temporal trajectory includes monitoring a temporal trajectory of the user's finger or the object relative to the virtual frame;
if the monitored temporal trajectory corresponds to natural shakiness of the user's finger,
maintaining a cursor position on the display; and
adjusting a spatial position of the virtual frame based on the monitored temporal trajectory to counteract the natural shakiness of the user's finger.

6. The method of claim 1, further comprising:
if the monitored temporal trajectory corresponds to natural shakiness of the user's finger,
determining if the monitored temporal trajectory corresponds to a slight motion of the user's finger or the object; and
if the monitored temporal trajectory corresponds to a slight motion, individually mapping the monitored spatial positions of the user's finger or the object to a corresponding cursor position on the display.

7. The method of claim 1, further comprising:
if the monitored temporal trajectory corresponds to natural shakiness of the user's finger,
performing a linear regression on the monitored temporal trajectory to derive a linear fit; and
if the linear fit has a slope greater than a predetermined threshold, individually mapping the monitored spatial positions of the user's finger or the object associated with the user's finger to a corresponding cursor position on the display.

8. A method implemented in a computing device having a processor, a detector, and a display operatively coupled to one another, the method comprising:
detecting a plurality of spatial positions of a user's finger or an object associated with the user's finger with respect to time, wherein the user's finger or the object is spaced apart from the display;
calculating a section length and a direction change for a plurality of pairs of consecutive detected spatial positions of the user's finger or the object; and
determining if a temporal trajectory formed by the plurality of spatial positions of the user's finger or the object correspond to natural shakiness of the user's finger based on the calculated section lengths and direction changes.

9. The method of claim 8 wherein calculating the section length and the direction change includes:
calculating a section length as a distance between a pair of consecutive detected spatial positions of the user's finger or the object; and
calculating an angle change between a first pair of detected spatial positions and a second pair of detected spatial positions.

10. The method of claim 8 wherein calculating the section length and the direction change includes:
calculating a section length as a distance between a pair of consecutive detected spatial positions of the user's finger or the object; and
calculating an angle change between a pair of consecutive sections as an angle between a first pair of detected spatial positions and a second pair of detected spatial positions, the first pair and the second pair sharing one spatial position.

11. The method of claim 8 wherein:
calculating the section length and the direction change includes:
determining a number of sections formed by the plurality of detected spatial positions, the sections individually having a section length greater than a length threshold; and
calculating angle changes between all pairs of consecutive sections with a section length greater than the length threshold;
determining if the temporal trajectory formed by the plurality of spatial positions of the user's finger or the object correspond to natural shakiness includes:
if the determined number of sections is greater than a count threshold and all calculated angle changes are less than an angle threshold, indicating the plurality of spatial positions of the user's finger or the object associated with the user's finger do not correspond to natural shakiness; and
if the determined number of sections is lower than the count threshold or one of the angle changes is larger than the angle threshold, indicating the plurality of spatial positions of the user's finger or the object associated with the user's finger correspond to natural shakiness.

12. The method of claim 8 wherein calculating the section length and the direction change includes:
determining a number of sections formed by the plurality of detected spatial positions, the sections individually having a section length greater than a length threshold; and
calculating angle changes between all pairs of consecutive sections with a section length greater than the length threshold.

13. The method of claim 8 wherein calculating the section length and the direction change includes:
determining a number of sections formed by the plurality of detected spatial positions, the sections individually having a section length greater than a length threshold; and
calculating an angle change between at least two pairs of consecutive sections with a length greater than a length threshold.

14. The method of claim 8 wherein:
calculating the section length and the direction change includes:
determining a number of sections formed by the plurality of detected spatial positions, the sections individually having a section length greater than a length threshold; and
calculating angle changes between all pairs of consecutive sections with a length greater than a length threshold; and
determining if the temporal trajectory formed by the plurality of spatial positions of the user's finger or the object correspond to natural shakiness includes if the determined number of sections is greater than a count threshold and the calculated angle changes are less than an angle threshold, indicating the plurality of spatial positions of the user's finger or the object associated with the user's finger do not correspond to natural shakiness.

15. The method of claim 8 wherein:
calculating the section length and the direction change includes:
determining a number of sections formed by the plurality of detected spatial positions, the sections individually having a section length greater than a length threshold; and
calculating an angle change between at least two pairs of consecutive sections with a length greater than a length threshold; and
determining if the temporal trajectory formed by the plurality of spatial positions of the user's finger or the object correspond to natural shakiness includes if the determined number of sections is lower than a count threshold or the calculated angle change is larger than an angle threshold, indicating the plurality of spatial positions of the user's finger or the object associated with the user's finger correspond to natural shakiness.

16. The method of claim 8 wherein:
calculating the section length and the direction change includes:
determining a number of sections formed by the plurality of detected spatial positions, the sections individually having a section length greater than a length threshold; and
calculating angle changes between all pairs of consecutive sections with a length greater than a length threshold; and
determining if the temporal trajectory formed by the plurality of spatial positions of the user's finger or the object correspond to natural shakiness includes if the determined number of sections is lower than a count threshold or at least one of the angles changes is larger than an angle threshold, indicating the plurality of spatial positions of the user's finger or the object associated with the user's finger correspond to natural shakiness.

17. A computing device, comprising:
a detector configured to detect a position of a user's finger or an object associated with the user's finger spaced apart from the display;
a processor operatively coupled to the detector; and
a non-transitory computer readable medium storing instructions, when executed by the processor, causing the processor to perform a process including:
forming a temporal trajectory based on the detected positions of the user's finger or the object;
correlating the formed temporal trajectory to a command or move instruction for the processor;
modifying instructions in a buffer based on the correlated command or move instruction; and
executing the instructions in the buffer with a predetermined amount of delay.

18. The computing device of claim 17 wherein modifying instructions in the buffer includes:
inserting a move instruction at a first time;
removing the inserted move instruction at a second time later than the first time; and
thereafter, inserting a command instruction into the buffer.

19. The computing device of claim 17, further comprising:
determining if the temporal trajectory correlates to a command or move instruction; and
if the temporal trajectory correlates to a command instruction, inserting the command instruction into the buffer and removing a move instruction previously inserted into the buffer, the move instruction being generated based on a portion of the temporal trajectory.

20. The computing device of claim 17, further comprising:
determining if the temporal trajectory correlates to a command or move instruction;
if the temporal trajectory correlates to a command instruction, inserting the command instruction into the buffer;
if the temporal trajectory does not correlates to a command instruction, determining if the temporal trajectory corresponds to natural shakiness of the user's finger;
if the temporal trajectory corresponds to natural shakiness of the user's finger, determining if the temporal trajectory corresponds to a slight motion; and
if the temporal trajectory corresponds to a slight motion, generating a move instruction according to the temporal trajectory and inserting the generated move instruction into the buffer.
